(19) United States
(12) Patent Application Publication
(10) Pub. No.: US 2009/0018723 A1
(43) Pub. Date: Jan. 15, 2009

(54) Driver/Vehicle Interface Combining Dynamic Function Modification of Vehicle Controls with Haptic Feedback

(76) Inventors: Dan Chevion, Haifa (IL); Tal Drory, Haifa (IL); Oleg Goldshmidt, Hartzelia (IL); Ron Sivan, Haifa (IL); Onn Shehory, Yahud (IL)

Correspondence Address: IBM CORPORATION, T.J. WATSON RESEARCH CENTER, P.O. BOX 218, YORKTOWN HEIGHTS, NY, 10598, US

(21) Appl. No.: 11/776,570

(22) Filed: Jul. 12, 2007

(51) Int. Cl. G05D 1/00

(52) U.S. Cl. 701/36

(57) ABSTRACT

A vehicle control system including a vehicle and a vehicle controller for receiving information regarding the vehicle and its environment and vehicle control input via a vehicle control, applying control logic predefined for the vehicle control input and the information to determine an aspect of the vehicle to control and how to control the aspect, and sending a control directive to at least one vehicle subsystem to carry out the determined control of the aspect, where when the vehicle is in a first operational state the controller allows the vehicle control input to control the vehicle subsystem directly related to the vehicle control input without modification by the controller, and where when the vehicle is in a second operational state the controller uses the vehicle control input to determine a vehicle objective and sends the control directive to any of the vehicle subsystems in order to achieve the vehicle objective.

### FIELD OF THE INVENTION

The present invention relates to vehicle control in general, and more particularly to vehicle control and driver-vehicle interfaces.

### BACKGROUND OF THE INVENTION

The advent of “smart” vehicles and infrastructure promises to automate much of the task of driving. However, it will be some time before the human driver may be completely done away with. In the interim, there is a need to balance increasing vehicle autonomy with the level of control and responsibility that drivers maintain for their vehicles' actions.

### SUMMARY OF THE INVENTION

The present invention is intended to improve vehicle operation without wresting vehicle control from the hands of the operator. It does so using computer-assisted vehicle control whereby undesirable vehicle behavior, such as getting very close to another vehicle or obstacle, or colliding with it, is made more difficult to accomplish by dynamically limiting or changing the effect of one or more vehicle controls. The driver is preferably kept aware of such dynamic changes through signals, such as via haptic feedback through the affected controls. Automated vehicle control is preferably provided such that:
1. The behavior of the vehicle controls (e.g., steering wheel and pedals) is maintained such that the need for driver retraining is limited;
2. The driver is given full control of the vehicle, such that he/she remains responsible for the vehicle's actions; and
3. The vehicle is provided with a varying degree of autonomy whereby the vehicle may safely make some driving decisions while still satisfying condition 2 above.

The automated vehicle control system of the present invention preferably mediates between the vehicle controls, through which the driver conveys his/her intents regarding the vehicle's behavior, and the underlying vehicle systems that directly affect vehicle behavior (e.g., acceleration).

In one aspect of the present invention a vehicle control system is provided including a vehicle, and a vehicle controller configured to receive information regarding the vehicle and its environment, receive vehicle control input via at least one vehicle control of the vehicle, apply control logic predefined for the received vehicle control input and the information, thereby determining at least one aspect of the vehicle to control and how to control the aspect, and send a control directive to at least one vehicle subsystem to carry out the determined control of the aspect, where when the vehicle is in a first operational state the vehicle controller allows the vehicle control input to control the at least one vehicle subsystem directly related to the vehicle control input without modification by the vehicle controller, and where when the vehicle is in a second operational state the vehicle controller uses the vehicle control input to determine a vehicle objective and sends the control directive to any of the vehicle subsystems in order to achieve the vehicle objective.

### BRIEF DESCRIPTION OF THE DRAWINGS

The present invention in embodiments thereof will be understood and appreciated more fully from the following detailed description taken in conjunction with the appended drawings in which:

FIG. 1 is a simplified illustration of an automated vehicle control system, constructed and operative in accordance with an embodiment of the invention;

FIG. 2A is a simplified conceptual illustration of an exemplary operational scenario in which the system of FIG. 1 is employed; and

FIG. 2B is a simplified illustration of an exemplary method of operation of the system of FIG. 1, operative in accordance with an embodiment of the invention.

### DETAILED DESCRIPTION OF THE INVENTION

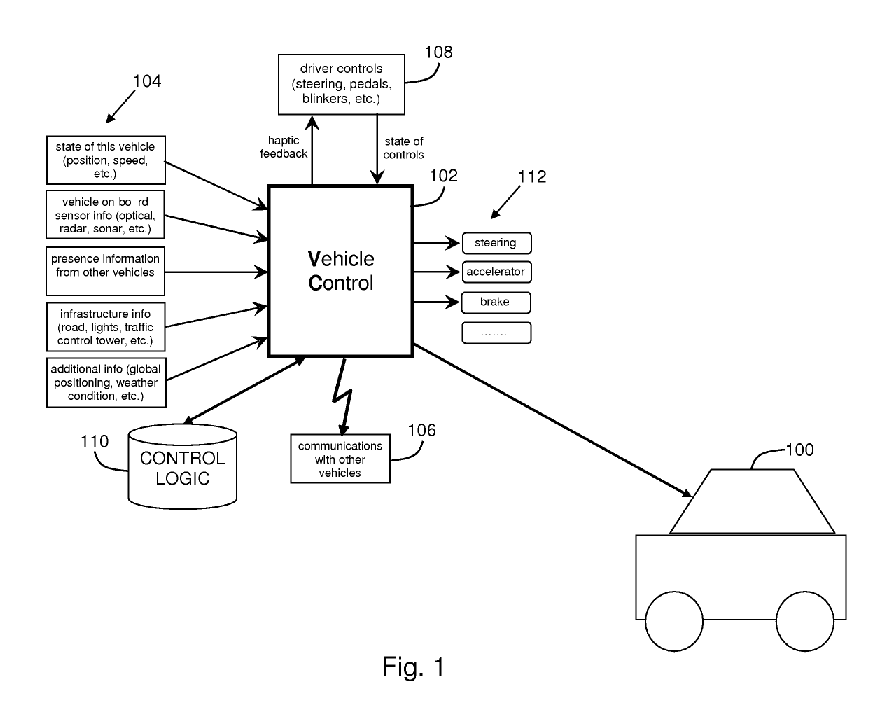

Reference is now made to FIG. 1, which is a simplified illustration of an automated vehicle control system, constructed and operative in accordance with an embodiment of the invention. In the system of FIG. 1 a vehicle 100 is configured with a vehicle controller 102 for receiving information regarding vehicle 100 and its environment from one or more sources 104. Such information may include: vehicle state information, such as the location, speed and acceleration of vehicle 100; vehicle on-board sensor information; information regarding the locations and speeds of nearby vehicles which may be determined by sensors on either vehicle 100 or on any of the nearby vehicles and communicated to vehicle 100 via a communications facility 106; infrastructure information such as road, light, and traffic sign information; and other information such as weather and global positioning system information. Vehicle controller 102 receives vehicle control input from the driver via one or more vehicle controls 108, such as the steering wheel, accelerator, and brake, applies any predefined control logic 110 that may be applicable to the received vehicle control input and information from sources 104, and thus determines what aspect of vehicle 100 to control and how to control it. Vehicle controller 102 then sends control directives to one or more applicable vehicle subsystems 112 to carry out the determined control.

Vehicle controller 102 also preferably provides haptic feedback to the driver through vehicle controls 108. Such feedback is preferably produced when the vehicle control input provided by the driver via vehicle controls 108 differs by a predefined measure from the action vehicle controller 102 actually takes when controlling vehicle 100 after applying control logic 110 to the vehicle control input. For example, if the accelerator pedal is depressed to indicate a desired rate of acceleration and/or speed, but the acceleration rate or speed it would normally entail exceeds a safety margin, vehicle controller 102 may decide to accelerate the vehicle at a slower rate or not at all and/or achieve a lower speed than the driver requests. Vehicle controller 102 preferably controls the accelerator pedal using conventional techniques to resist the driver's pressure on the pedal, conveying to the driver that the driver's command has been overridden.

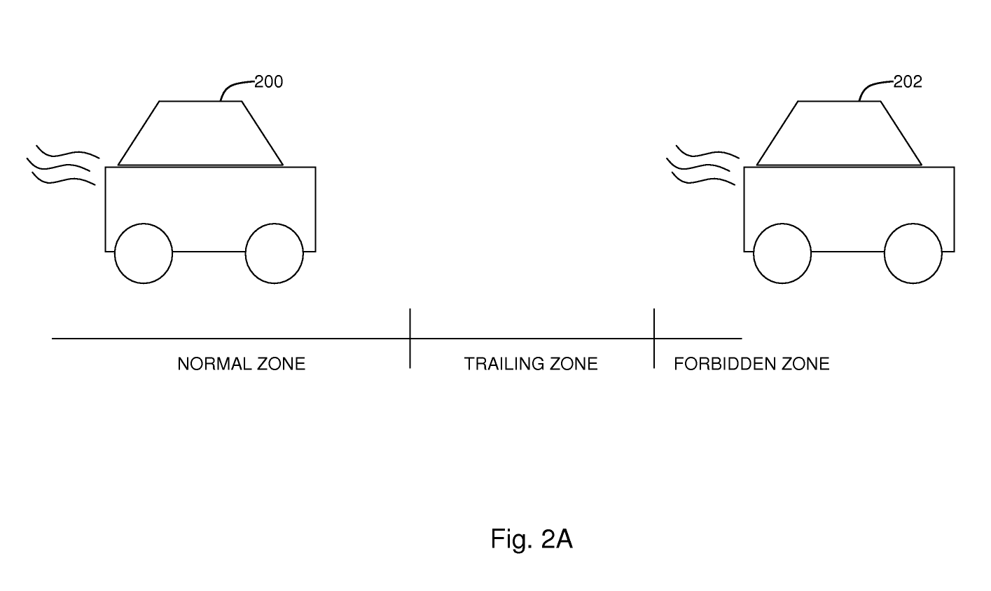

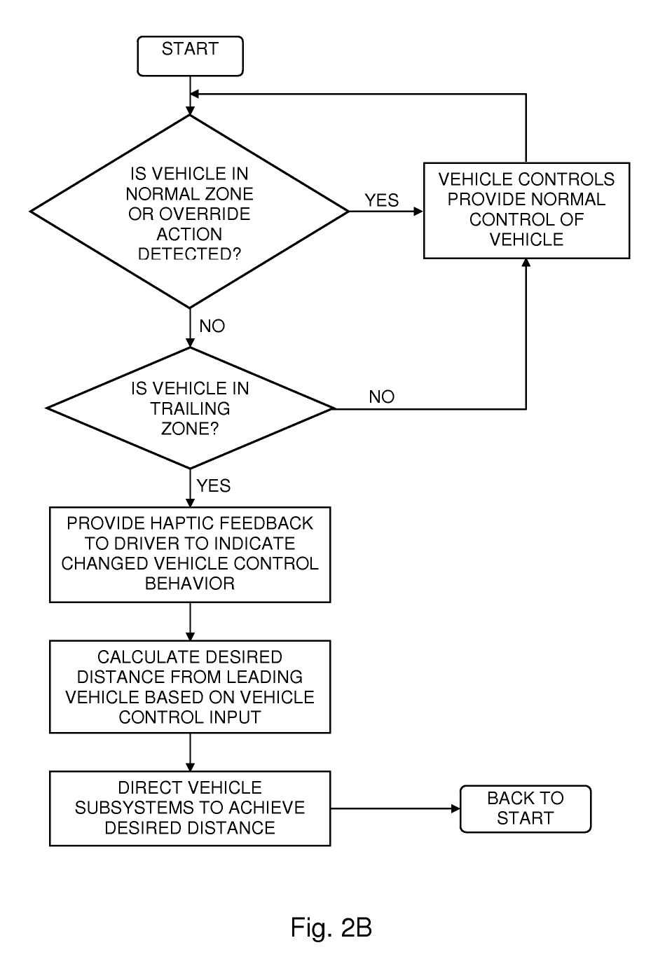

Reference is now made to FIG. 2A, which is a simplified conceptual illustration of an exemplary operational scenario in which the system of FIG. 1 is employed, and additionally to FIG. 2B, which is a simplified illustration of an exemplary method of operation of the system of FIG. 1, operative in accordance with an embodiment of the invention. In FIG. 2A a vehicle 200, employing the system of FIG. 1, is shown following a vehicle 202. In a first operational state, such as when vehicle 200 is beyond a predefined distance from vehicle 202, such as may be determined using conventional techniques including a proximity detector employed by vehicle 200, vehicle 200 is said to be within a “normal zone” (hereinafter “NZ”) with respect to vehicle 202. While vehicle 200 is within the normal zone vehicle controller 102 allows vehicle control input provided by the driver via vehicle controls 108 to directly control one or more vehicle subsystems 112 without modification by vehicle controller 102. For example, when the driver presses the accelerator while in the normal zone, vehicle controller 102 allows the accelerator to directly control fuel flow to achieve a desired acceleration and speed. In a second operational state, such as when vehicle 200 is within a predefined distance from vehicle 202, vehicle 200 is said to be within a “trailing zone” (hereinafter “TZ”) with respect to vehicle 202. While vehicle 200 is within the trailing zone vehicle controller 102 uses vehicle control input provided by the driver via vehicle controls 108 to determine a vehicle objective, such as a desired distance from vehicle 202. Vehicle controller 102 calculates the desired distance from vehicle 202 and then sends control directives to one or more applicable vehicle subsystems 112 in order to achieve the desired distance. For example, when the driver presses the accelerator while in the trailing zone, vehicle controller 102 determines, using conventional techniques, the degree to which the accelerator pedal is depressed, and calculates a corresponding desired distance from vehicle 202. Thus, for example, if the accelerator pedal is depressed at 5% of its possible range of travel, vehicle controller 102 preferably controls the fuel flow of vehicle 200 in order to place vehicle 200 at 5% of the distance from the boundary of the trailing zone farthest from vehicle 202. If the accelerator pedal is depressed at 50% of its possible range of travel, vehicle controller 102 preferably controls the fuel flow of vehicle 200 in order to place vehicle 200 at 50% of the distance from the boundary of the trailing zone farthest from vehicle 202. A “forbidden zone” between the trailing zone and vehicle 202 may be defined such that vehicle controller 102 does not allow vehicle 200 to enter the forbidden zone unless the driver performs an override action, such as depressing the accelerator in excess of 95% of its possible range of travel while vehicle 200 is within the trailing zone. Thus, increasing the degree to which the accelerator pedal is depressed while in the trailing zone is interpreted by vehicle controller 102 to mean “decrease the distance from vehicle 202.” Vehicle controller 102 will then control the rate of fuel flow in order to speed the vehicle up until the desired distance from vehicle 202 is reached. If the accelerator is then maintained at its new position and vehicle 202 maintains its current speed, vehicle controller 102 preferably controls the rate of fuel flow of vehicle 200 in order to maintain the desired distance from vehicle 202. Conversely, decreasing the degree to which the accelerator pedal is depressed while in the trailing zone is interpreted by vehicle controller 102 to mean “increase the distance from vehicle 202.” Vehicle controller 102 will then control the rate of fuel flow in order to slow the vehicle down until the desired distance from vehicle 202 is reached. If the accelerator is then maintained at its new position and vehicle 202 maintains its current speed, vehicle controller 102 preferably controls the rate of fuel flow of vehicle 200 in order to maintain the desired distance from vehicle 202.

Vehicle controller 102 preferably provides haptic feedback to the driver through vehicle controls 108, such as by causing the accelerator to vibrate upon entering and leaving the trailing zone in order to indicate to the driver that the behavior of the accelerator has been changed as described above, and/or by providing varying degrees of resistance in proportion to the degree with which the driver depresses the accelerator while vehicle 200 is within the trailing zone.

The driver may indicate his desire to leave the trailing zone mode by performing an override action, such as when the driver activates the turn signal when changing lanes, in which case vehicle controller 102 preferably reverts to normal zone mode, allowing the driver to directly control fuel flow.

Distances between vehicles moving at similar speeds, and thus the boundaries of the various zones described above, may be stated in terms of travel time. For example, the trailing zone (TZ) boundary farthest from vehicle 202 may be set at a distance from vehicle 202 such that vehicle 200 would take dTZ seconds to traverse the TZ at its present speed. The forbidden zone (FZ) boundary may similarly be set for a traversal time of dFZ, where dTZ>dFZ. The boundaries for TZ are also preferably determined based on a predefined minimum stopping distance, being the distance in which stopping without the assistance of vehicle controller 102 is difficult, such as where the distance to vehicle 202 is too short for the driver of vehicle 200 to notice and brake his vehicle in time, whereas the minimum distance from vehicle 202 would be safe if vehicle controller 102 were configured to automatically initiate the braking action. The extent of the FZ is typically set such that even automatic braking within the FZ would be unsafe. Typical values are dTZ=2 secs. and dFZ=0.5 secs.

Vehicle controller 102 may maintain vehicle 200 at a fixed travel-time distance from vehicle 202 by adjusting its speed to follow the speed changes of vehicle 202. Alternatively, this may be performed asymmetrically, such as where vehicle 200 slows down as much as vehicle 202 does, but where vehicle 200 only accelerates to a limited degree as a result of vehicle 202 accelerating, such as where vehicle 200 accelerates to the speed with which vehicle 200 was traveling just before it last entered the TZ plus some fixed amount, say 25 km/h, or percentage of its present cruising speed, such as 15%, or some limit imposed by other modes in effect, such as curve following. For example, a fixed addition may be used in low speed, stop-and-go traffic below a predefined speed threshold, whereas a percentage may be used when cruising at higher speeds above a predefined speed threshold. In this manner vehicle 200 may be prevented from being “pulled ahead” by a fast vehicle passing vehicle 200 and planting itself in front of vehicle 200.

Vehicle controller 102 may be configured to allow vehicle 200 to enter the TZ only when it is clear the driver does not intend to pass vehicle 202. The driver may indicate his intention to pass vehicle 202 by using the turn signal, by depressing the accelerator pedal into an override position, or by activating a special control dedicated to this purpose, among other possibilities, whereupon vehicle 200 does not slow unless and until the FZ is reached.

Vehicle controller 102 may be configured to control vehicle 200 as it approaches stationary objects, where vehicle 200 would slow to a complete stop to avoiding hitting a stationary object while allowing the driver to come close to the object by depressing the accelerator, or even to touch the object by performing an override action. In this case the width of the FZ may be set to zero or eliminated altogether. This may be employed during parallel parking, where the driver may freely depress the accelerator and depend on vehicle controller 102 to slow and/or stop vehicle 200 to avoid hitting other parked cars. When moving in reverse, a vehicle behind vehicle 200 is considered to be the vehicle being “trailed” as described above.

The present invention is believed to improve the driving experience by:

Improving safety, by automatically performing a vehicle control action quicker than a human driver could;

Making driving easier in general, by relieving the driver of the necessity to make conscious decisions and physical efforts to adjust the vehicle's motion to rapidly changing traffic situations;

Providing faster automatic response to advance other goals, such as improving traffic flow; and

Maintaining ultimate driver control and responsibility for the vehicle.

It is appreciated that the present invention may be applied to stop-and-go traffic where the speeds of the vehicles involved are relatively slow. A vehicle operating in this mode may stop completely when the vehicle it is tracking stops, and may start moving again when the tracked vehicle starts to move. Currently available vehicle control systems, such as Adaptive Cruise Control, are specifically disabled at low speeds to prevent the vehicle from suddenly moving forward and injuring pedestrians that may have stepped in front of the stopped vehicle. The present invention is believed to solve this problem by allowing the driver to actively and constantly control the distance between the driver's vehicle and the vehicle immediately ahead. Were a driver, using the present invention, to instinctively remove his foot from the accelerator to avoid hitting a pedestrian, the vehicle would leave the trailing mode, and the vehicle would no longer automatically accelerate to keep up with the vehicle ahead.

It is further appreciated that the present invention may be applied while the driver is parking a vehicle. Normally, parallel parking between closely parked cars requires several back and forth maneuvers. Although self-parking vehicle systems are currently available, they do not give drivers control during the process. For example, the driver may wish to park closer to the curb in a narrow street to minimize obstruction of traffic, or conversely, further from a wall to allow easy access to the doors on the passenger side. Moreover, a driver may sometimes wish to stay clear of an obstacle thah an automated system may not notice, such as a puddle. The present invention may be applied during parking to avoid the curb, other parked cars, objects such as parking meters, etc., and haptically indicate to the driver when these obstacles are being approached too closely. In an exemplary scenario, a driver stops his vehicle next to a parking space and instructs the system, such as via a dedicated switch, to enter a parking mode of operation. Vehicle motion is then modified in two respects:
1. All motion is constrained by the space available between other obstacles, such as parked vehicles.
2. The steering wheel no longer directly controls the direction of the front tires, but rather directly controls the net lateral direction of the vehicle rightward or leftward, as well as the size of each lateral step into the parking space.

In all other respects the driver continues to control the vehicle normally, controlling forward and reverse motion of the vehicle using the gear control, and the distance from obstacles in the vehicle's path using the gas pedal. The vehicle may employ vehicle control as described hereinabove regarding the stop-and-go traffic.

Unless stopped by the driver, the vehicle will move as far as it can in the direction indicated, automatically turning the tires leftward and rightward as needed, ending in a parallel position within the parking space that is closer to the curb by an amount determined by the degree of steering wheel rotation. In order to move the vehicle laterally, all the driver needs to do is to switch from forward to reverse and back, while constantly keeping the steering wheel turned in the direction of the desired lateral movement. The lateral displacement component is preferably proportional to the degree of steering wheel rotation from a home position. As the driver moves the steering wheel back to its home position, the vehicle will take increasingly smaller lateral steps, and will halt when the wheel returns to its center position. The lateral component of each forward and backward movement may be limited by a predefined maximum angle of attack, or one that is determined by a predefined function given measured distances to the curb and/or other obstacles bounding the parking space. The steering wheel preferably haptically conveys to the driver when the degree of rotation of the steering wheel would result in an angle of attack of each lateral movement that is greater than the maximum angle of attack. Thus, the driver may select any desired angle of attack up to the maximum angle of attack, or may override the maximum angle using an override mechanism such as is described hereinabove.

The driver may control the distance of the vehicle from obstacles in its path using the gas pedal as described hereinabove, while allowing for driver override.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A vehicle control system comprising:
a vehicle; and
a vehicle controller configured to
receive information regarding said vehicle and its environment,
receive vehicle control input via at least one vehicle control of said vehicle,
apply control logic predefined for said received vehicle control input and said information, thereby determining at least one aspect of said vehicle to control and how to control said aspect, and
send a control directive to at least one vehicle subsystem to carry out said determined control of said aspect,
wherein when said vehicle is in a first operational state said vehicle controller allows said vehicle control input to control said at least one vehicle subsystem directly related to said vehicle control input without modification by said vehicle controller, and
wherein when said vehicle is in a second operational state said vehicle controller uses said vehicle control input to determine a vehicle objective and sends said control directive to any of said vehicle subsystems in order to achieve said vehicle objective.

2. The system according to claim 1 wherein said vehicle controller is additionally configured to provide haptic feedback through any of said vehicle controls.

3. The system according to claim 2 wherein said vehicle controller provides said haptic feedback when said vehicle control input differs by a predefined measure from said determined control.

4. The system according to claim 2 wherein said vehicle controller provides said haptic feedback when said vehicle enters or leaves any of said operational states.

5. The system according to claim 2 wherein said vehicle controller provides said haptic feedback in proportion to a measure of said vehicle control input.

6. The system according to claim 1 wherein said vehicle is in said first operational state when said vehicle is beyond a predefined distance from another vehicle.

7. The system according to claim 1 wherein said vehicle is in said second operational state when said vehicle is within a predefined distance from another vehicle.

8. The system according to claim 1 wherein said information includes any of the location of said vehicle, the speed of said vehicle, the acceleration of said vehicle, the location of another vehicle, the speed of another vehicle, infrastructure information including any of road, light, and traffic sign information, and weather and global positioning system information.

9. The system according to claim 1 wherein said vehicle objective is a desired distance from another vehicle.

10. The system according to claim 9 wherein said desired distance is determined in proportion to the degree to which an accelerator pedal of said vehicle is depressed.

11. A vehicle control method comprising:
receiving information regarding a vehicle and its environment;
receiving vehicle control input via at least one vehicle control of said vehicle;
applying control logic predefined for said received vehicle control input and said information, thereby determining at least one aspect of said vehicle to control and how to control said aspect; and
sending a control directive to at least one vehicle subsystem to carry out said determined control of said aspect,
wherein when said vehicle is in a first operational state said applying step comprises allowing said vehicle control input to control said at least one vehicle subsystem directly related to said vehicle control input without modification, and
wherein when said vehicle is in a second operational state said applying step comprises using said vehicle control input to determine a vehicle objective and said sending step comprises sending said control directive to any of said vehicle subsystems in order to achieve said vehicle objective.

12. The method according to claim 11 and further comprising providing haptic feedback through any of said vehicle controls.

13. The method according to claim 12 wherein said providing step comprises providing said haptic feedback when said vehicle control input differs by a predefined measure from said determined control.

14. The method according to claim 12 wherein said providing step comprises providing said haptic feedback when said vehicle enters or leaves any of said operational states.

15. The method according to claim 12 wherein said providing step comprises providing said haptic feedback in proportion to a measure of said vehicle control input.

16. The method according to claim 11 wherein said vehicle is in said first operational state when said vehicle is beyond a predefined distance from another vehicle.

17. The method according to claim 11 wherein said vehicle is in said second operational state when said vehicle is within a predefined distance from another vehicle.

18. The method according to claim 11 wherein said receiving information step comprises receiving any of the location of said vehicle, the speed of said vehicle, the acceleration of said vehicle, the location of another vehicle, the speed of another vehicle, infrastructure information including any of road, light, and traffic sign information, and weather and global positioning method information.

19. The method according to claim 11 wherein said applying step comprises determining said vehicle objective as a desired distance from another vehicle.

20. A computer program embodied on a computer-readable medium, the computer program comprising:
a first code segment operative to receive information regarding a vehicle and its environment;
a second code segment operative to receive vehicle control input via at least one vehicle control of said vehicle;
a third code segment operative to apply control logic predefined for said received vehicle control input and said information, thereby determining at least one aspect of said vehicle to control and how to control said aspect; and
a fourth code segment operative to send a control directive to at least one vehicle subsystem to carry out said determined control of said aspect,
wherein when said vehicle is in a first operational state said third code segment is operative to allow said vehicle control input to control said at least one vehicle subsystem directly related to said vehicle control input without modification, and
wherein when said vehicle is in a second operational state said third code segment is operative to use said vehicle control input to determine a vehicle objective and said sending step comprises sending said control directive to any of said vehicle subsystems in order to achieve said vehicle objective.
